(19) United States
(12) Patent Application Publication
(10) Pub. No.: US 2025/0001603 A1
(43) Pub. Date: Jan. 2, 2025

(54) INTEGRATION OF A RISK ASSESSMENT OF A COLLISION BETWEEN A ROBOTIC DEVICE AND A HUMAN OPERATOR

(71) Applicant: Fraunhofer-Gesellschaft zur Förderung der angewandten Forschung e.V., München (DE)

(72) Inventors: Roland BEHRENS, Magdeburg (DE); Sebastian HERBSTER

(21) Appl. No.: 18/291,761

(22) PCT Filed: Jul. 28, 2022
(86) PCT No.: PCT/EP2022/071220

§ 371 Date: Jan. 24, 2024

(30) Foreign Application Priority Data
Jul. 30, 2021 (DE) 10 2021 208 279.3

(51) Int. Cl. B25J 9/16

(52) U.S. Cl. CPC B25J 9/1676; B25J 9/1653

(57) ABSTRACT

The invention relates to the integration of a risk assessment for a collision between a robotic device (26) and a human operator into a controller (20) intended for the robotic device (26), with a) reading (1) command data (24) from a program module (21) which is intended for transmission to a control module (22) when used as intended, by an assessment module (23); and/or b) reading (2) machine data (25) from a control module (22) which data specifies the robotic device (26) by the assessment module (23); c) determining (8) at least one hazard risk based on the read data and at least one stored associated risk profile (k, k+1), which contains necessary information for automatically determining the respective hazard risk, by the assessment module (23); d) classifying (9) the determined hazard risk by the assessment module (23); e) as a function of a result of the classification (9): i) determining (10) one or more measures (27, 28) for reducing the hazard risk and outputting (11) the determined measure or measures (27, 28) for respective selection by a user, or ii) outputting a warning to the user; f) after the selection (12) of at least one measure (27, 28) by the user: outputting (13) a control signal for implementing the selected measure or measures (27, 28) in the program module (21) and/or in the control module (22) by the assessment module (23) in order to simplify the risk assessment.

The invention relates to a computer-implemented method for integrating a risk assessment of a collision between a robotic device and a human operator of the robotic device in a controller intended for the robotic device. The invention also relates to a corresponding computer program product, a corresponding controller and a robotic device equipped with the controller.

For robotic devices which work hand in hand or side by side with human operators, known as collaborative robots or cobots, the applicable standards such as for example DIN EN ISO 10218-2 and additionally ISO/TS 15066 specify various requirements which enable the safe operation of the robotic device. In the particular case of genuine collaboration, where physical contact is allowed between a human and a robotic device, in the “power and force limitation” safety operating mode the standards specify various biomechanical limits which the robotic device must not exceed in the event of a collision with the human operator. When the robotic device complies with the limits the risk of injury in the event of a collision, for example in the event of impact, jamming or shearing, is sufficiently reduced according to the nominative requirements. In general, in the context of the present disclosure, any type of physical contact between a robotic device and human operator can be understood to be a collision which is or may be the basis of a hazard to the human operator. For example, the hazard can be mechanical and/or chemical and/or thermal and/or electrical in nature. For example, contact with an adhesive surface, such as a gluing tool of the robotic device, can be defined as a collision. In this case, the hazard risk to be determined as described below may include or be a chemical hazard risk, such as poisoning as an injury. For cooperation between the robotic device and human operator, i.e. working in parallel with the robotic device without intended physical contact, the “speed and distance monitoring” safety operating mode specifies a minimum distance between the human operator and the robotic device. As soon as this minimum distance is fallen below, the robotic device must stop and remain in the stopped state until the minimum distance is reestablished. The approach described in the following relates primarily to these two safety operating modes, but is not limited to them.

A risk assessment is defined as a procedure which in defined steps analyses the health risks posed by the robotic (or other) device, and identifies and takes measures to reduce risks to health. A risk analysis comprises the following steps:

Step 1: Determining the limits of the (robotic) device, for example limits of use, but also identifying technical, temporal and spatial limits as well as other descriptive features of the (robotic) device.

Step 2: Identifying hazards for operators in the environment of the (robotic) device, for example quantifying collisions in the event of incorrect behavior by the operator or incorrect application of the (robotic) device.

Step 3: Assessing risks which arise from the previously identified hazards, for example by forming a product from a probability of the conditions of occurrence with the possible extent of damage of the hazard that has occurred according to the condition of occurrence.

Step 4: Calculating the risk value and assigning the hazard risk to a risk class, for example a low, medium and high hazard risk, based on appropriately determined limits for the calculated and thereby quantified risk value.

Step 5: Determining measures for reducing the risk, for example informing relevant operators about low risks in training sessions, reducing medium risks by means of technical protective measures, and eliminating high risks by structurally reconfiguring the (robotic) device.

Step 6: Validating the effectiveness of the measures implemented, for example by corresponding measurements.

In collaborative robotic devices low risks are in fact mainly reduced by training the operators at risk. To reduce medium risks, the requirements for the suitable safety operating mode for the respective application are implemented, for example by complying with biomechanical limits in the “power and force limitation” or the minimum distances in the “speed and distance monitoring” operating mode. The proof of compliance with or meeting the requirements of the selected safety operating mode, i.e. the effectiveness of the measures taken as described in step 6, is usually provided by a measurement process in which situations identified as hazardous are simulated on the real robotic device and analyzed and evaluated using special measuring devices. As is also known from other devices (machines) high risks require a structural reconfiguration which completely eliminates the source of danger, for example removing or rounding sharp edges.

In the prior art, the risk assessment is a manual process which takes into account all of the life phases of a (robotic) device, from the planning stage to the time of starting regular operation as well as its disassembly and disposal. Only when the person starting up or operating the (robotic) device has carried out all of the steps and documented them in detail can they issue a CE mark declaration in the European Union to confirm that the (robotic) device complies with the legal requirements of the European Machinery Directive, currently MRL 2006/42/EG, and therefore also the requirements of the applicable harmonized standard, such as for example DIN EN ISO 10218-1/-2.

Compliance with the requirements of the selected safety operating mode, for example complying with biomechanical limits, achieves a sufficient reduction of medium risks within the meaning of the applicable standards and the Machinery Directive. The conditions for the metrological verification of the effectiveness of the measures concerned are derived from the information compiled in writing in the risk assessment. They show the examiner inter alia which situations are associated with hazards for the operator. From these situations the examiner then selects the time point, for example the moment in the program sequence, and the areas, for example points on the surface of the robotic device, which need to be checked by measurements for proof of effectiveness.

Determining the time of measurement and producing the measurement arrangement is very time-consuming as the written and sometimes incomplete information in the risk assessment often lacks important details that are necessary for the proper execution and documentation of the measurement, such as the speed of the robotic device at the relevant point at the time of the collision. In addition to the large amount of effort required, the transfer of information for setting the measurement points is a potential source of error that can have a negative impact on the accuracy of the metrological assessment.

In addition, every time a change is made to a robotic device that has already been put into operation, it needs to be checked whether the change is a significant change that affects the validity of the risk assessment. If new hazards are added as a result of the change, the existing risk assessment loses its validity and the (robotic) device can no longer be operated. The operator of the (robotic) device thus needs to check whether a significant change has taken place and if so which components of the risk assessment are affected by the planned or implemented changes. Only once the check has been completed it is clear whether the measures undertaken for reducing the risk are still effective or whether new measures need to be taken which could result in the complete reconfiguration of the (robotic) device.

The objective is therefore to simplify a risk assessment, in particular for a change to a (robotic) device after its initial start-up.

This problem is solved by the subject-matters of the independent claims. Advantageous embodiments are given in the dependent claims, the description and the figures.

One aspect relates to a computer-implemented method for integrating a risk assessment of a collision between a robotic device and a human operator of the robotic device into a controller intended for the robotic device. The controller may be coupled or not coupled to the robotic device, as it may be sold separately for example. The robotic device may comprise in particular a so-called cobot, a collaborative robot, or in general any other device, a machine. The robotic device may comprise in particular a robot arm with one or more links. The method comprises a series of method steps:
one method step is reading command data from a program module of the controller, which, when the controller and thus the robotic device are used as intended, are provided for transmission to a control module of the controller and thus for use in the control module by an assessment module of the controller. The program module, control module and also the assessment module can be implemented in respective microprocessors, or also in a common microprocessor or a common microprocessor arrangement, for example a computer. The controller, for example the computer, can be coupled to a (real or virtual) robotic device when in use. The program module is used to program the robotic device, the control module is used to control the robotic device according to the programming saved in the program module, wherein the control module controls the robotic device according to the command data of the program module corresponding to the programming.

Alternatively or in addition to reading the command data, the assessment module reads machine data from the control module of the controller, which specifies the robotic device, in particular technical characteristics of the robotic device. It is also possible to read further data, including additional machine data from other sources, for example databases, the Internet, or from user input. For example, a type designation of the robotic device can be read as machine data, and then further machine data, for example dimensions, geometries and masses of the robotic device can be read as technical characteristics from another source, for example the Internet or a local database.

A further method step is determining, in particular quantifying, at least one hazard risk, i.e. one or more hazard risks, based on the read command and/or machine data and at least one stored risk profile associated with the respective hazard risk, which contains information required for the automatic determination of the respective hazard risk, by the assessment module. Several different hazards and thus hazard risks can also be associated with a risk profile. For example, the respective hazard risk can be determined or quantified by using an algorithm (in particular by simulation). A user of the method can enter further data required for determining the hazard risk that has not been read or can be prompted to enter missing data. Part of the determination can therefore be the addition of information required for determining the hazard risk.

For example, a hazard risk can be determined in that the probabilities of one or more corresponding occurrence conditions (which can be part of the required information) can be multiplied by a potential extent of damage (which can be part of the required information). The determined hazard risk is also classified by the assessment module, wherein different further steps are initiated by the assessment module as a function of the results of the classification: namely issuing a warning to the user, in particular displaying information about the hazard risk, and/or determining one or more measures for reducing the hazard risk and outputting, in particular displaying, the measure or measures for selection or approval by a user. The warning can also be output via a control signal. After at least one measure has been selected or approved by the user of the method described here, the assessment module outputs a control signal for implementing the selected measure or measures in the program module and/or in the control module. The control signal can be output directly to the program module and/or control module, alternatively or additionally also to a display module, which prompts the user to implement the selected measure. The measure or measures selected by the user can therefore be implemented automatically after they have been approved or selected by the assessment module.

With this approach, the risk assessment steps can be integrated into the program process, as the risk assessment and the programming of the robotic devices are merged with one another by reading the command data. For example, the determination of the at least one hazard risk and the following steps can be carried out parallel to programming the program module, either by continuously reading the command data or by repeatedly reading the command data triggered by a trigger event such as the lapse of a predetermined time period or change of the command data stored in the program module. This means that the method can already be used when planning a work sequence for the robotic device. In this approach, individual sub-steps of the risk assessment are analyzed specifically, which means that the relevant data is automatically stored in the assessment module and thus made available in a coherent and transparent manner in the data management and documentation for the risk assessment.

The risk profiles create a direct link between the read data and the hazard risks, which makes it easy to update the risk assessment when the robotic device is modified, but also allows measures for reducing the respective hazard risks to be identified, proposed and automatically implemented directly and even automatically. The proposed method is thus based on the finding that processes for programming the robotic device and carrying out the risk assessment, which were previously carried out independently and separately, are partly based on the same data, which previously had to be identified manually and transferred to the other system. Therefore, synergies can be used when combining the programming and risk assessment. In the described method the digitally available data, i.e. the command data and the machine data, is determined independently and used for the risk assessment. The risk profiles used for determining a hazard risk can be used by a user of the method and if necessary added to and/or changed. Accordingly, the assessment module can also be used by the user to request missing data in the risk profile, which is however required for the respective determination of an existing hazard risk. The requested information can for example relate to the circumstances of a hazard such as probabilities of the occurrence conditions of a respective hazard and/or the occurrence conditions of a respective hazard and/or the severity or potential damage of a respective hazard. The risk profiles can thus contain information, in addition to the automatically determined information from the command data and/or machine data, that the assessment module requests interactively in dialog with the user. The data can also be stored permanently in the assessment module or in the respective risk profile. By issuing the warning to the user or issuing respective measures for selection by a user it is ensured that the responsibility for the risk assessment remains with the user of the method in compliance with the law. The risk assessment thus can be simplified in a legally compliant manner.

The integrated risk assessment presented here reduces the amount of time that operators of robotic devices currently spend analyzing the risks of their application in accordance with legal and regulatory requirements. Programmers with little previous experience of carrying out a risk assessment benefit from the improvements in particular. The linking of the risk assessment with the control and programming of the robotic device ensures a continuous exchange of data and information, that the creators of a risk assessment currently have to painstakingly compile and document. The possibility of using the data to carry out simulations to determine the hazard potential or suitable protective measures means that the integrated risk assessment creates further added value for the user. As the integrated risk analysis is a fully digitalized method of risk assessment, it can also be used in the planning of applications. The risk assessment prepared during the planning can then be continued, refined and finalized once the application has been set up. The advantage of using the integrated risk assessment in the planning is that it helps to harmonize the respective application with the applicable safety requirements and thus avoid planning errors.

In one advantageous embodiment it is provided that the risk profile comprises one or more of the following items of information, namely information on the type of collision, in particular whether the collision is a collision with a mechanical hazard, in particular a jam, for example a (comparatively slow) virtually stationary jam, or impact, for example free impact or a (comparatively rapid) jamming impact, or another kind of collision, in particular a collision with a chemical hazard, for example an adhesive, and/or a collision with a thermal hazard, for example a soldering tool, and/or a collision with an electrical hazard, for example a welding tool; information on the type of body part of the human operator at risk form the collision, in particular specification of the body part at risk and/or a biomechanical limit for the body part at risk; information on a position of a contact point of the robotic device involved in the collision, in particular a shape of the robotic device at the contact point; information on the posture of the human operator during the collision; information on the frequency and/or probability of the collision, for example in the form of probabilities of occurrence conditions of respective hazards and/or occurrence conditions of respective hazards; information on a way of avoiding the hazard; information on the severity of the collision; in particular the severity of injury of the human operator during the collision. As described above, any type of physical contact between a robotic device and human operator can be defined as a collision which is or can be a hazard for the human operator. The said information can be stored in particular in the form of standardized multiple-choice structures, which on the one hand makes it easier for the user to add the information to the risk profile due to the standardization and on the other hand also makes it easier to use the information in the assessment module by means of corresponding algorithms or simulations due to the standardization. The said information is particularly useful for determining the hazard risk.

In one advantageous embodiment it is provided that, in particular before determining the hazard risk, one or more of the risk profiles are linked to one or more respective program sections of the command data by means of user input. A program section can be part of a movement command or consist of several movement commands or comprise several movement commands. It is also possible, to assign several risk profiles to a program section so that program sections of different risk profiles intersect or are part of one another. In particular, the user input can also be used to specify an occurrence condition for the hazard which is assigned to the hazard risk that corresponds to the respective risk profile. By linking the risk profiles with sections of the program the assessment module has direct and real-time access to various states of the robotic device, for example positions and speeds, so that information such as for example the position and speed of the robotic device at the time of the hazard is precisely available for determining the hazard risk. Accordingly, this information no longer has to be painstakingly determined and documented by hand but can be retrieved precisely. Thus for example also the potential extent of damage can be determined more precisely.

In a further advantageous embodiment it is provided that before determining the hazard risk, in particular after reading the machine data and/or command data, usage limits of the robotic device are defined by a user input, which limit a spatial range and/or speed range and/or force range used by the robotic device when used as intended. This has the advantage that the state space of the robotic device, in which hazard risks are determined and measures are identified for reducing the hazard risk, is reduced so that the method becomes faster and more reliable.

In a further advantageous embodiment, it is provided that if it is determined that a risk profile is an incomplete risk profile which does not contain all of the information required for automatically determining the respective hazard risk, the user is automatically prompted to complete the risk profile by means of user input. The accuracy of the method can be increased in this way.

In a further advantageous embodiment it is provided that when classifying the determined hazard risk the respective hazard risk is classified into one of at least three or exactly three classes: a low risk class, a medium risk class and a high risk class. In particular, the respective warning can be output to the user in the event that the hazard risk is classified as low risk or high risk, and the measure or measures for reducing the hazard risk can be determined and issued for selection by the user in the event that the hazard risk is classified as medium risk. For example, if simulation results show that the potential extent of damage of a hazard in combination with the probability of occurrence conditions represents a medium risk, the assessment module can propose adequate and targeted measures for reducing risk, for example a speed limit, at which the robotic device would comply with the applicable biomechanical limits. In addition, the assessment module can use the data to determine ideal moments and places, i.e. instances and locations, for the correct and reliable validation of an actual risk of injury and compile this in a plan. This plan can be output and can thus show the user of the method precisely in which situations and at which locations the robotic device needs to be checked metrologically in order to be able to assess the effectiveness of the measures taken to reduce medium risks.

In a further advantageous embodiment it is provided that the one or more measures for reducing the hazard risk comprise specifying movement limits, in particular speed limits, in the program module and/or at least one parameter for one or more safety functions, for example an emergency shutdown, in the control module. The measures can also be additionally selected depending on a respectively set safety operating mode, for example the “power and force limitation” safety operation mode or the “speed and distance monitoring” safety operation mode. These measures are particularly suitable for automatically reducing the hazard risk.

In a further advantageous embodiment it is provided that the data read from the program module and/or control module are read repeatedly, and in the event of a change to the previously read data it is checked whether the change to the data also involves a change to one of the at least one associated hazard risks, and, if this is case, the method steps of determining at least one hazard risk, classifying the determined hazard risk, and determining the measures for reducing the hazard risk with the output for selection by the user or output of the warning to the user and, after the selection of at least the one measure by the user, outputting a control signal for implementing the selected measure or measures in the program module and/or control module for the changed data. This provides a validation function which ensures that the validity of the risk assessment is maintained or the risk assessment is adjusted and new measures for reducing the hazard risk are proposed if the robotic device changes. The validation function can also be used in a planning phase for a system with the robotic device, for example with a virtual robotic device.

One aspect also relates to a computer program product, comprising commands, which when the program is executed by a computer cause the computer to execute the method according to one of the described embodiments.

A further aspect relates to a controller for a robotic device, for integrating a risk assessment of a collision between a human operator and the robotic device, with a program module, a control module, and an assessment module. The assessment module is configured to read command data from the program module, which data is provided for transmission to the control module of the control device and thus for use in the control module when the control device and thus the robotic device are used as intended, and/or machine data from the control module which specify the robotic device, and also to determine at least one hazard risk based on the read data and at least one stored risk profile associated with a hazard risk, which contains information required to automatically determine the respective hazard risk, to determine a least one hazard risk and to classify to the determined hazard risk, to determine either one or more measures for reducing the hazard risk as a function of a result and to output the measure or measures for selection by the user or to output a warning to a user, and to output a control signal for implementing the selected measure or measures in the program module and/or in the control module after the selection of at least one measure by the user.

Advantages and advantageous embodiments of the controller correspond to advantages and advantageous embodiments of the method described.

A further aspect relates to a robotic device with such a controller.

The features and combinations of features mentioned above in the description, also in the introductory part, as well as the features and combinations of features mentioned below in the description of the figure and/or shown only in the figures can be used not only in the combination indicated, but also in other combinations, without departing from the scope of the invention. Thus, embodiments of the invention, which are not explicitly shown and explained in the figures but which emerge and can be produced from the explained embodiments but with separate combinations of features, are also to be regarded as covered and disclosed by the invention. Embodiments and combinations of features are also regarded as disclosed which thus do not have all the features of an originally formulated independent claim. Furthermore, embodiments and combinations of features, are to be regarded as disclosed, in particular by the embodiments set out above, which go beyond or deviate from the combinations of features set out in the references of the claims.

With reference to the schematic drawings shown in the following Figures, the subject-matter according to the invention is explained in more detail, without limiting it to the specific embodiments shown here.

In the drawings:

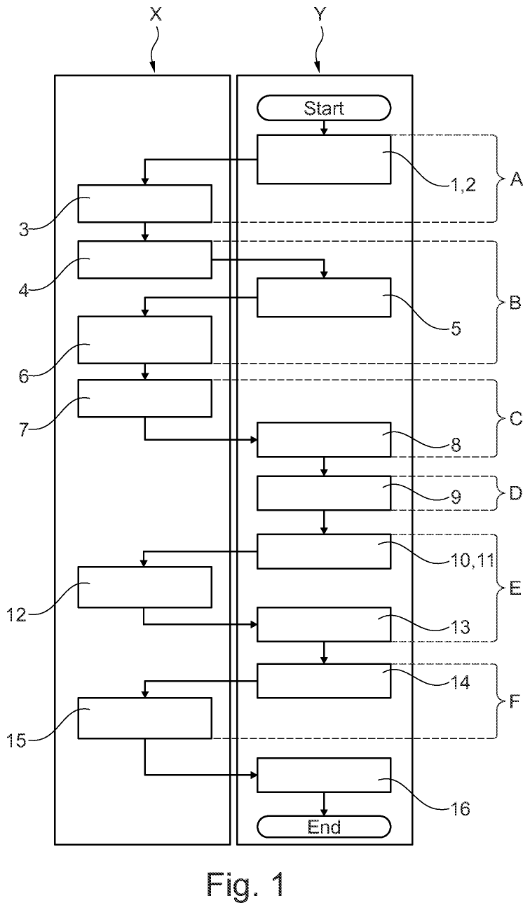

FIG. 1 shows an exemplary embodiment of the method;

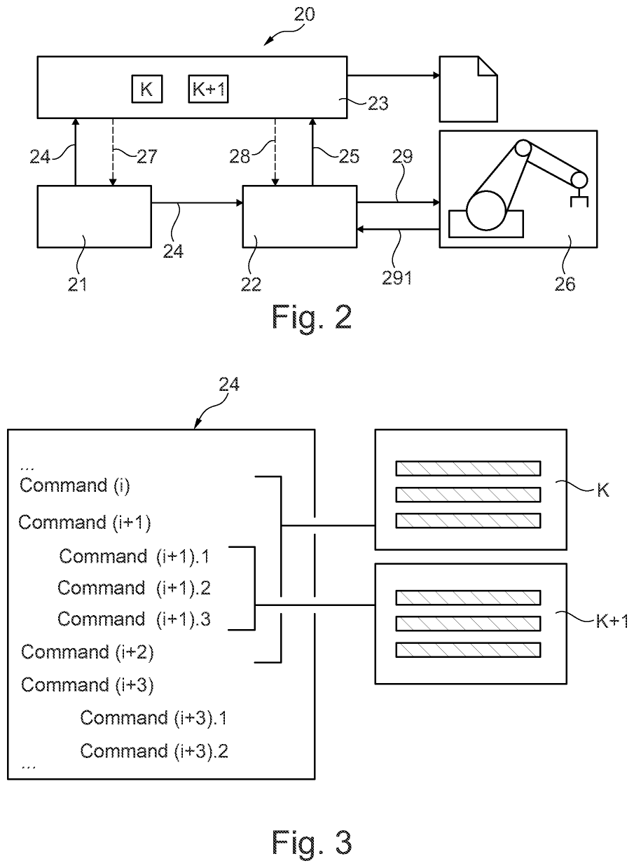

FIG. 2 shows a schematic representation of an example of a controller with an associated robotic device; and

FIG. 3 shows an example of an illustration of the assignment of different risk profiles to program sections of the command data.

Identical or functionally identical elements are denoted by the same reference signs.

FIG. 1 shows an example of a risk assessment. A distinction is made here between the method steps X carried out by the user and the method steps Y carried out by the assessment module. In the shown example, once the method has started firstly command data 24 (FIG. 2) is read 1 and machine data 25 (FIG. 2) is read 2. This is followed by setting usage limits 3 for the robotic device 26 (FIG. 2) via a user input. As part A of the method, the reading 1, 2 and setting 3 correspond to step 1 of the risk assessment, setting the limits of the robotic device.

At step 3 there is a completion 4 of a risk profile k, k+1 (FIG. 3) stored in the assessment module 23 (FIG. 2) which contains information required for the automatic determination 8 (see below) of an associated hazard risk. This is followed by saving 5 the completed risk profile and in the present case also linking 6 one or more risk profiles with one or more respective program sections of the command data by means of a user input. The completion 4, saving 5 and linking 6 as section B of the method thus correspond to step 2 of the usual risk assessment, the identification and description of hazards for operators in the environment of the robotic device.

In the example shown, linking 6 is followed by specifying 7 one or more occurrence conditions for a respective hazard, in particular with an assigned probability of occurrence. This is followed by determining 8 at least one hazard risk based on the read data and the at least one stored risk profile assigned to the respective hazard risk. Specifying 7 and determining 8 as section C of the method correspond to step 3 of the conventional risk assessment, the assessment of risks which arise from the previously identified hazards.

The determination 8 is followed by classification 9 of the identified hazard risk, which as section D also corresponds to step 4 of the known risk assessment, calculating a risk value and if necessary assigning a risk class.

Depending on the result of the classification 9, in the next step 10 in the shown example one or more measures 27, 28 (FIG. 2) for reducing the hazard risk are determined and after this in step 11 the measure or measures are output for selection by a user. This is followed by selecting 12 at least one measure by the user as well as in this case automatically implementing the selected measure or measures by outputting 13 a corresponding control signal. Steps 10 to 13 corresponds as section D of the method to step 5 in the conventional risk assessment, determining measures for risk minimization, providing information about low risks, reducing medium risks and eliminating high risks.

In the example presented, the output 13 is followed by the automatic creation of a plan for safety validation 14 with an indication of the situation and the points at which the robotic device needs to be checked by measurement in order to evaluate the effectiveness of the measures taken to reduce the hazard risk. This plan is followed by an implementation 15 of the plan for safety validation by the user, as the assessment module should not check itself. Alternatively or additionally, a validation module can also be provided which replaces or supplements the measurement by the user with a model-based approach, i.e. a simulation. Steps 14 and 15, as section F of the method described here, correspond to step 6 in the conventional risk assessment, validating the effectiveness of the measures implemented.

Finally, in this example, a corresponding documentation of the method is automatically created and output which comprises all the relevant data.

FIG. 2 shows a schematic representation of a controller for implementing the method as well as a corresponding robotic device. The controller 20 comprises a program module 21, a control module 22, and an assessment module 23. The assessment module 23 is configured to read command data 24 from the program module 21 which is intended for transmission to the control module 22. Alternatively or additionally, the assessment module 23 is configured to read machine data 25, which specifies the robotic device 26. Furthermore, the assessment module 23 is configured to determine at least one hazard risk, based on the read data 24, 25 and at least one stored associated risk profile k, k+1 (FIG. 3), which contains information required to automatically determine the respective hazard risk, to classify the determined hazard risk, and as a function of the result of the classification, to determine either one or more measures 27 which relate to the program and thus the program module and/or one or more measures 28 which relate to the control system and thus the control module 22, to reduce the hazard risk and to implement these measures in the program module 21 and/or the control module 22 after selection or approval by a user. The control module 22 is used to control the robotic device 26 by means of corresponding signals 29, 291.

FIG. 3 shows an example of a set of command data with commands (i), (i+1), (i+2), (i+3) and (i+1).1, (i+1).2, (i+1).3 and (i+3).1, (i+3).2 and an example of linking of risk profiles k, k+1. In the shown example a first risk profile k is linked to the commands i, i+1 and i+2 of a first command group, and thus also to the subcommands (i+1).1, (i+1).2, (i+1).3 belonging to the command (i+1). A further risk profile k+1 is linked here exclusively to the subcommands (i+1).1, (i+1).2, (i+1).3, so that the said sub-profiles are linked both with the risk profile k and with the risk profile k+1. This is an example of the possibility of flexible and precise assessment of the risks that occur.

1. A method for integrating a risk assessment of a collision between a robotic device and a human operator into a controller intended for the robotic device, the method comprising:
a) reading command data from a program module, wherein the command data is intended for transmission to a control module when used as intended, by an assessment module;
b) reading machine data from the control module, wherein the machine data specifies the robotic device, by the assessment module;
c) determining at least one hazard risk of at least one hazard based on at least one of the read command data or the read machine data and at least one saved associated risk profile, which contains information required for automatically determining a respective hazard risk, by the assessment module;
d) classifying the determined respective hazard risk by the assessment module;
e) as a function of a result of the classification:
i) determining one or more measures for reducing the respective hazard risk and outputting the determined one or more measures for respective selection by a user; or
ii) outputting a warning to the user; and
f) after selecting the one or more measures by the user, outputting a control signal for implementing the selected one or more measures in at least one of the program module or the control module by the assessment module.

2. The method according to claim 1, wherein the at least one saved associated risk profile comprises one or more of:
information on a type of collision;
information on a type of body part of the human operator at risk from the collision;
information on a position of a contact point of the robotic device involved in the collision;
information on the posture of the human operator at the time of the collision;
information on at least one of a frequency or probability of the collision;
information on at least one way of avoiding the at least one hazard; or
information on a severity of damage of the collision.

3. The method according to claim 1, wherein before determining the at least one hazard risk, one or more of the at least one saved associated risk profile is linked by a user input to one or more respective program sections of the command data, wherein the user input specifies a condition of occurrence of the at least one hazard, which is assigned to the at least one hazard risk corresponding to the at least one saved associated risk profile.

4. The method according to claim 1, wherein before determining the respective hazard risk, after reading at least one of the command data or the machine data, one or more usage limits of the robotic device are defined by a user input, wherein the one or more usage limits limit at least one of a spatial range, speed range, or force range used by the robotic device during intended use.

5. The method according to claim 1,
wherein responsive to a determination that a particular risk profile is an incomplete risk profile that does not contain all of the information required for automatically determining the respective hazard risk, the user is requested to complete the incomplete risk profile.

6. The method according to claim 1, wherein in the classification of the determined respective hazard risk, the respective hazard risk is classified into one of three classes, a low risk class, medium risk class and high risk class, wherein a respective warning is output to the user when the respective hazard risk is classified as low risk or high risk, and wherein the one or more measures for reducing the respective hazard risk are determined and output for respective user selection when the respective hazard risk is classified as medium risk.

7. The method according to claim 1, wherein the one or more measures for reducing the respective hazard risk comprises specifying at least one of one or more movement limits, in the program module or at least one parameter for one or more safety functions in the control module.

8. The method according to claim 1, wherein the data read from the program module and/or control module are read repeatedly, and responsive to a change from previously read data, currently read data is checked to determine whether the change to the data also involves a change to at least one of the one or more respective hazard risks, and, responsive to a change to at least one of the one or more respective hazard risks, steps c), d), e), and f) are performed for the changed data.

9. A computer program product, comprising commands which, when the program is implemented by a computer, cause the computer to:
read command data from a program module, wherein the command data is intended for transmission to a control module when used as intended by an assessment module;
read machine data from the control module, wherein the machine data specifies a robotic device by the assessment module;
determine at least one hazard risk of at least one hazard based on at least one of the read command data or the read machine data and at least one save associated risk profile, wherein the at least one associated risk profile contains information required for determining a respective hazard risk by the assessment module;
classify the respective hazard risk by the assessment module, and, as a result of the classification:
determine one or more measures for reducing the respective hazard risk and output the one or more measures for respective selection by a user; or
outputting a warning to the user; and
responsive to a selection of the one or more measures by the user, output a control signal for implementing the selected one or more measures in at least one of the program module or the control module by the assessment module.

10. A controller for a robotic device, for integrating a risk assessment of a collision between a human operator and the robotic device, comprising:
a program module;
a control module; and
an assessment module, wherein the assessment module is configured, to:
read at least one of command data from the program module, which data is provided for transmission to the control module during the intended use, or machine data from the control module which specifies the robotic device;
determine at least one hazard risk of at least one hazard based on the read data and at least one saved associated risk profile, which contains information required for automatically determining the at least one hazard risk;
classify the determined at least one hazard risk, and as a function of a result of the classification either i) to determine one or more measures for reducing the at least one hazard risk and output one or more measures for respective selection by a user or ii) output a warning to the user; and
after at least one measure has been selected by the user, output a control signal for implementing the selected at least one measure in the program module and/or in the control module.

11. The controller according to claim 10, wherein the controller is included in a robotic device.

12. The method according to claim 2, wherein the information on a type of collision includes whether the collision is a jam or an impact collision.

13. The method according to claim 2, wherein the information on a type of body part of the human operator at risk from the collision includes at least one of a specification of the body part at risk or a biomechanical limit valve of the body part at risk.

14. The method according to claim 2, wherein the information on a position of a contact point of the robotic device involved in the collision includes a shape of the robotic device at the contact point.

15. The method according to claim 2, wherein the information on a severity of damage of the collision includes a severity of injury of the human operator in the collision.

16. The method according to claim 7, wherein the one or more movement limits includes one or more speed limits.

17. The method according to claim 7, wherein the one or more safety functions includes an emergency shutdown.
